(19) United States
(12) Patent Application Publication
(10) Pub. No.: US 2026/0146057 A1
(43) Pub. Date: May 28, 2026

(54) PRECIPITATION AND ISOLATION OF GADOLINIUM COMPLEX

(71) Applicant: BRACCO IMAGING S.P.A., Milan (IT)

(72) Inventors: Andrea BANIN, Collegno (IT); Andrea BARALE, Bibiana (IT); Valeria BOI, Strambino (IT); Sonia GAZZETTO, Cascinette d'Ivrea (IT); Federica BUONSANTI, Torino (IT)

(73) Assignee: BRACCO IMAGING S.P.A., Milan (IT)

(21) Appl. No.: 19/118,461

(22) PCT Filed: Oct. 5, 2023
(86) PCT No.: PCT/EP2023/077641

§ 371 Date: Apr. 4, 2025

(30) Foreign Application Priority Data
Oct. 7, 2022 (EP) 22200259.4

(51) Int. Cl. C07F 15/00

(52) U.S. Cl. CPC C07F 15/00

(57) ABSTRACT

The present invention relates to a method for precipitating the gadolinium complex of formula (I) from a solution comprising such gadolinium complex by means of mixing a first solution comprising the complex with a second solution, as well as to a method for isolating the precipitated gadolinium complex of formula (I) from a mixture comprising the precipitate: the gadolinium complex of formula (I) can be used as a contrast agent for magnetic resonance imaging (MRI).

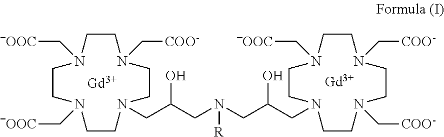

### TECHNICAL FIELD

The invention relates to the precipitation and isolation of gadolinium complexes, the latter being useful as contrast agents for magnetic resonance imaging (MRI).

### BACKGROUND ART

Magnetic Resonance Imaging (MRI) is a well-known diagnostic imaging technique that is used in clinical diagnostics for a growing number of indications. Gadolinium (Gd(III)) complexes are commonly used as contrast agents in MRI.

WO 2017/098044 discloses dimeric Gd(III) complexes useful as contrast agents in MRI, such as the dimeric Gd(III) complex [μ-[1-[bis [2-(hydroxy-κO)-3-[4,7,10-tris [(carboxy-κO)methyl]-1,4,7,10-tetraazacyclododec-1-yl-κN¹,κN⁴,κN⁷,κN¹⁰]propyl]amino]-1-deoxy-D-glucitolate(6-)]]digadolinium complex having the following formula (from here on, Compound 1)

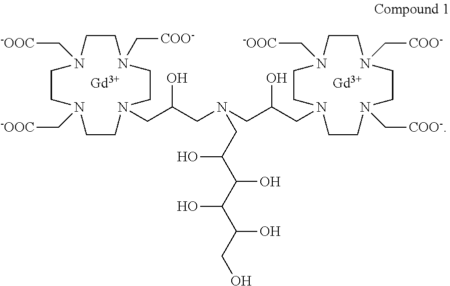

Compound 1 displays great relaxivity, and in particular a relaxivity that is more than 2-fold higher than the relaxivity displayed by Dotarem® and ProHance® (Non-Specific contrast agents currently in use in the diagnostic practice). Accordingly, Compound 1 is a promising contrast agent for in vivo MRI diagnostic imaging.

WO 2017/098044 further discloses the preparation of Compound 1 and its isolation from the reaction mixture by spray drying.

Similarly, WO 2022/023240 discloses the preparation of Compound 1 and its isolation from the reaction mixture by either spray drying or lyophilization.

Spray drying and lyophilization effectively allow isolating Compound 1, thus providing a powder with good handling features and preserving the quality thereof. However, some drawbacks are associated to these two methods, such as high energy consumption, the requirement of costly dedicated equipment, and absence of purification, meaning that substantially all the impurities that are present within the solution of the complex to be isolated will be also present in the powder obtained by spray drying or by lyophilization. For these reasons, there is the need to provide further techniques for isolating Compound 1 (as well as similar complexes) from the reaction mixtures thereof that overcome the drawbacks outlined above.

### SUMMARY OF THE INVENTION

The invention relates to a method for precipitating the complex of formula (I) from a solution thereof

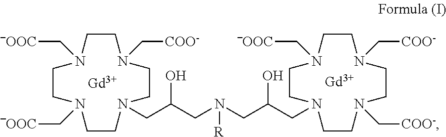

for example, for precipitating Compound 1 from a solution thereof

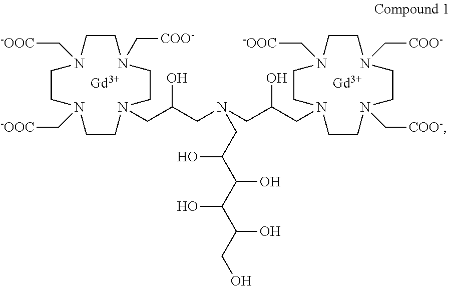

as set out in the claims.

This method allows selectively precipitating the complex by means of mixing two solutions, one of which comprises the complex and the other one comprising ethanol, which is used as an anti-solvent. Accordingly, the method of the invention provides for precipitating the complex with low energy consumption and does not require particular dedicated equipment in order to be carried out. Furthermore, the precipitate obtained by this method is filterable, whereby it can be easily separated and thus, isolated, from the mixture thereof. Moreover, the precipitating method possesses high yields and purifying power, in that it allows precipitating selectively the complex from the solution thereof; accordingly, the method of the invention provides a precipitate of the complex that contains less impurities compared to the starting solution comprising the complex. Additionally, it has been surprisingly found that the method of the invention does not substantially modify the diastereoisomeric ratio of the complex of formula (I), in particular when Compound 1 is used. These and other advantages are illustrated in more details in the sections below.

The present invention further relates to a method for isolating the complex of formula (I) from a mixture thereof as set out in the claims.

### DETAILED DESCRIPTION OF THE INVENTION

A first aspect of the invention is a method for precipitating the complex of formula (I) from a solution thereof

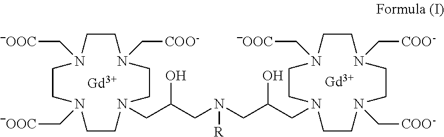

wherein R is a C₂-C₆-alkyl substituted by at least one hydroxyl (—OH) group, said method comprising the following steps:
a) providing a first solution comprising the complex of formula (I);
b) providing a second solution comprising ethanol; and
c) mixing the first solution of step a) with the second solution of step b) to precipitate the complex of formula (I).

As used herein, the term “Cₓ-C_{y}-alkyl”, wherein x and y denote two integer numbers, refers to straight or branched hydrocarbon chains with a number of carbons comprised between x and y; for example, the term “C₂-C₆-alkyl” refers to straight or branched hydrocarbon chain having from 2 to 6 carbon atoms.

As mentioned above, the method of the invention provides for mixing a first solution comprising the complex of interest, and a second solution working as an anti-solvent. Accordingly, the method of the invention does not require dedicated equipment and high energy consumption (or at least, a lesser extent of energy consumption compared to the known spray drying and lyophilization methods) to be carried out.

Moreover, using a second solution comprising ethanol provides a precipitate of the complex that is filterable, and that can thus be easily isolated from the mixture thereof. As showed in the Experimental section below, it has been found that using an anti-solvent comprising different solvents than ethanol, such as methanol and iso-butanol, the complex of interest does not precipitate or is not filterable.

Furthermore, the method of the invention provides a selective precipitation of the complex with good yields. As the precipitation is selective toward the complex, the method of the invention allows obtaining a filterable precipitate that contains a lower amount of the impurities as compared to the amount that was present within the solution of the complex before its precipitation. This advantage further characterizes the method of the invention compared to the prior art, because the known methods to isolate the complex of interest, namely spray drying and lyophilization, provided filterable precipitates containing all the impurities that the starting solution contained.

Additionally, it has been surprisingly found that the method of the invention does not substantially modify the diastereoisomeric ratio of the complex of formula (I), particularly when Compound 1 is used. In particular, Compound 1 has several stereocenters, whereby several diastereomers thereof exist. These diastereomers might have different chemical and physical properties between each other, such as different solubility. As the method of the invention provides for the precipitation of the complex within a solvent-anti-solvent mixture, a change of the diasteroisomeric ratio (i.e., a change in the amount, relative to each other, of at least some of the diastereomers before and after precipitation) could have been expected, because some diastereomers could have been more or less soluble than other(s). However, as showed in the Experimental section below, this surprisingly does not occur, whereby the method of the invention allows maintaining approximatively the same diastereoisomeric ratio.

According to an embodiment of the invention, R is a C₃-C₆-alkyl substituted by at least one hydroxyl (—OH) group, preferably a C₄-C₆-alkyl substituted by at least one hydroxyl (—OH) group, more preferably a C₅-C₆-alkyl substituted by at least one hydroxyl (—OH) group, and even more preferably a C₆-alkyl substituted by at least one hydroxyl (—OH) group. According to an even more preferred embodiment, R is a C₆-alkyl substituted by 5 hydroxyl (—OH) groups, for example thus providing Compound 1

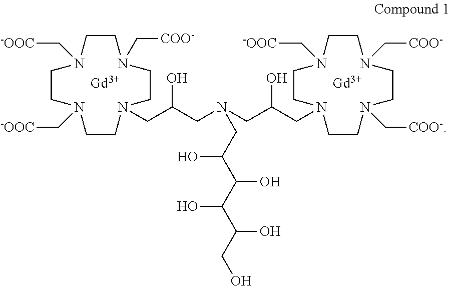

The first solution comprises the complex of formula (I) at least partially dissolved therein, possibly substantially completely dissolved therein. The first solution is preferably an aqueous solution. The first solution can advantageously be the reaction mixture from which the complex of formula (I) is obtained, for example the reaction mixture of the complexation step 5) disclosed in WO 2022/023240, possibly after one or more purification step(s). The first solution is advantageously miscible with the second solution (which indeed works as an anti-solvent).

The second solution comprises ethanol, preferably in an amount of at least 90.0 vol %. According to a more preferred embodiment, the second solution is absolute ethanol, that is a solution comprising at least 99.0 vol % of ethanol.

According to a preferred embodiment, the mixture prepared according to step c) further comprises at least a precipitating agent. The precipitating agent is selected from the group consisting of neutral salts of sodium and organic acids, preferably in an amount higher than 0.7 molar equivalents and lower than 10.0 molar equivalents with respect to the complex of formula (I). As showed in the Experimental section below, the precipitating agents improve the precipitation allowing to obtain a precipitate with good handling properties, in particular when the precipitating agent is present in the amounts disclosed above. According to a preferred embodiment, the precipitating agent is added to the first solution, whereby when such first solution is added to the second solution, or vice versa, in order to carry out the mixing step c), then the mixing of the complex of formula (I), of the anti-solvent (ethanol), and of the precipitating agent is obtained.

The term “neutral salts of sodium”, as used herein, refers to chemical compounds being an ionic assembly wherein the positively charged cation(s) is sodium and the negatively charged anion(s) is any inorganic anion, and wherein such neutral salts of sodium provide a substantially neutral solution (i.e. a solution having a pH of about 7) when dissolved into an aqueous media. Suitable examples of neutral salts of sodium are sodium chloride, sodium bromide, sodium iodide, sodium fluoride, sodium nitrate, and sodium sulfate; sodium chloride and sodium bromide being particularly preferred.

Preferably, the neutral salt of sodium is selected from the group consisting of sodium chloride, sodium bromide, sodium iodide, sodium fluoride, sodium nitrate and sodium sulfate; more preferably of sodium chloride and sodium bromide. As showed in the Experimental section below, these specific neutral salts of sodium, in particular sodium chloride and sodium bromide, aid the precipitation of the complex, and in particular allow obtaining high precipitation yields and a filterable precipitate with great handling properties that can be later isolated through conventional means. Moreover, as showed in the Experimental section below, other than providing a precipitate containing less impurities compared to the impurities present within the first solution, these specific neutral salts of sodium do not generate mono-gadolinated complexes. The term “mono-gadolinated complex”, as used herein, refers to a complex having the same structure as the dimeric complex of formula (I), but chelating only one gadolinium metal ion instead of two. Mono-gadolinated complexes do not show the favourable relaxometric properties of the complex of formula (I).

The term “organic acids”, as used herein, refers to substituted or unsubstituted carboxylic acids having one or more-COOH groups; suitable substitutions are for example hydroxyl (—OH) groups. Suitable examples of organic acids are acetic acid, lactic acid, tartaric acid, and citric acid; acetic acid and lactic acid being particularly preferred.

According to a preferred embodiment, the organic acid is a C₁-C₆-(hydroxy)alkyl-carboxylic acid, preferably a C₂-C₆-(hydroxy)alkyl-carboxylic acid, such as acetic acid, lactic acid, tartaric acid, and citric acid; more preferably, the organic acid is a C₁-C₆-(hydroxy)alkyl-carboxylic acid selected from the group consisting of acetic acid and lactic acid. Similarly to the neutral salts of sodium disclosed above, these organic acids aid the precipitation of the complex, and in particular allows obtaining high precipitation yields and a filterable precipitate with great handling properties that can be later isolated through conventional means.

The term “(hydroxy)alkyl-carboxylic acid”, as used herein, refers to straight or branched hydrocarbon chains wherein at least one hydrogen thereof is substituted by a carboxyl (—COOH) group, and that are optionally substituted by one or more hydroxyl (—OH) groups. The term “Cₓ-C_{y}-(hydroxy)alkyl-carboxylic acid”, wherein x and y denote two integer numbers, refers to a (hydroxy)alkyl-carboxylic acid as above defined with a number of carbons comprised between x and y; for example, the term “C₁-C₆-(hydroxy)alkyl-carboxylic acid” refers to a (hydroxy)alkyl-carboxylic acid as previously defined having from 2 to 6 carbon atoms.

Preferably, the precipitating agent is in an amount of 0.8 to 9.0 molar equivalents, more preferably of 0.9 to 5.0 molar equivalents, even more preferably of 0.9 to 3.0 molar equivalents, and most preferably of 1.0 to 2.0 molar equivalents, such as 1.0 to 1.5 molar equivalents, with respect to the complex of formula (I).

According to a preferred embodiment, the concentration of the complex within the first solution is 20% to 70% w/w, preferably 30 to 60% w/w, and more preferably 40 to 60% w/w.

Step c) provides for mixing the first solution to the second solution, preferably along with the precipitating agent, as previously defined in any embodiment thereof. The mixing step c) allows to precipitate the complex of formula (I) within the mixture of the first and second solution, thanks to the second solution working as an anti-solvent. This step can be easily carried out and advantageously does not require high energy consumption nor dedicated equipment. The mixing step c) can be carried out either by adding the first solution of step a) to the second solution of step b), or by adding the second solution of step b) to the first solution of step a), as showed in the Experimental section below, optionally further adding the precipitating agent according to any embodiment discussed above. The precipitating agent can alternatively be present in the first solution and/or in the second solution, preferably in the first solution, whereby the addition of the first solution to the second solution, or vice versa, allows precipitating the complex of formula (I). Such addition can be carried out dropwise, preferably for a time of 15 minutes to 6 hours, more preferably of 30 minutes to 4 hours, and even more preferably of 1 to 3 hours.

According to a preferred embodiment, the mixing of step c) is carried out so that the amount in weight of ethanol is from 1 to 20 times, preferably 2 to 15 times, more preferably 3 to 10 times, and even more preferably 4 to 8 times, with respect to the weight of the complex of formula (I).

A second aspect of the present invention is a method for isolating a complex of formula (I) from a mixture

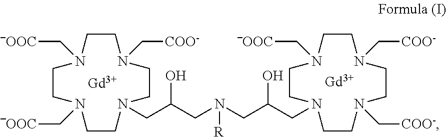

wherein R is a C₂-C₆-alkyl substituted by at least one hydroxyl (—OH) group, preferably a C₃-C₆-alkyl substituted by at least one hydroxyl (—OH) group, more preferably a C₄-C₆-alkyl substituted by at least one hydroxyl (—OH) group, even more preferably a C₅-C₆-alkyl substituted by at least one hydroxyl (—OH) group, and most preferably a C₆-alkyl substituted by at least one hydroxyl (—OH) group, comprising the following steps:
(i) carrying out the method for precipitating the complex of formula (I), for example according to any one of the embodiments thereof, to obtain a precipitate of the complex within a mixture; and
(ii) filtering out the precipitate of the complex from the mixture.

According to a preferred embodiment of the method for isolating, R is a C₆-alkyl substituted by 5 hydroxyl (—OH) groups, thus for example providing a method for isolating Compound 1 from a mixture

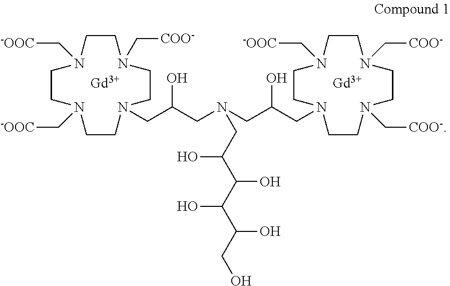

The method for isolating of the invention provides for carrying out the method for precipitating of the invention (step (i)), whereby the method for isolating has all the advantages of the method for precipitating of the invention. The method for isolating further provides for filtering out the precipitate of the complex (step (ii)); this can be achieved because the precipitate obtained by step (i) is filterable. The obtained precipitate has suitable to great handling properties and contains a low amount of impurities, thanks to the method of precipitating carried out in step (i).

Step (ii) can be carried out according to conventional means, such as by using a filter, for example a sintered glass funnel. After filtering out the precipitate, the latter can be washed one or more time, for example twice, with the second solution, for example with fresh absolute ethanol. The second solution is preferably at a temperature lower than 20° C., such as of about 5° C. to 10° C., during the washing(s). The washed precipitate can finally be dried through conventional means, such as in a static oven, possibly under vacuum.

According to a preferred embodiment of the method for isolating of the invention, before step (ii), and preferably after step (i), the temperature of the mixture is 20° C. or above, and such temperature is then lowered to a temperature of 0° C. to 10° C., preferably of 5° C., such lowering of temperature being also carried out before step (ii). Preferably, the temperature is gradually lowered for a time of 6 to 48 hours, more preferably of 12 to 36 hours, and even more preferably of 22.5 hours. This gradual lowering of temperature allows improving the filterability of the precipitate. The filterability can be further improved according to a particularly preferred embodiment, wherein the gradual lowering is carried out according to the following temperature ramp:
(ia) the mixture comprising the precipitate of the complex is maintained to 20° C. or above for 15 minutes to 1 hour, preferably for 30 minutes; then
(ib) the mixture is cooled to 0° C. to 10° C., preferably to 5° C., for 3 to 12 hours, preferably for 6 hours; and finally
(ic) the mixture is maintained to 0° C. to 10° C., preferably to 5° C., for 8 to 32 hours, preferably for 16 hours.

### Experimental Section

### Material and Methods

Reactants and/or solvents employed in the following Examples that are not specifically synthesized are known and readily available. If they are not commercially available per se, they may be prepared according to known methods in literature.

The water content (KF) in the following Examples has been determined by Karl Fischer titration using Titrator Compact V10S (Mettler Toledo) with the reactant HYDRANAL™ and as solvent anhydrous MeOH.

The NaCl content in the following Examples has been determined by argentometric titration using analytical grade AgNO₃.

The following HPLC procedure has been used to determine the diastereomeric distribution, the amount of mono-gadolinated complexes, and the main impurities Gd-DOTA and Gd-DO3A:

Column: Xselect HSS T3 150 × 3 mm 3.5 μm
Mobile phase: A = KH₂PO₄ + K₂HPO₄ 40 mM + EDTA 0.02 mM;
B = Phase A/ACN 60/40

| t (min) | A | B | Flow (ml/min) |
|---|---|---|---|
| 0 | 100 | 0 | 0.35 |
| 4 | 100 | 0 | 0.35 |
| 20 | 85 | 15 | 0.35 |
| 25 | 85 | 15 | 0.35 |
| 30 | 0 | 100 | 0.35 |
| 40 | 0 | 100 | 0.35 |
| 43 | 100 | 0 | 0.35 |
| 50 | 100 | 0 | 0.35 |

Inj Volume: 10 um
Temperature: 40° C.
Detector: DAD 210 nm + FLD λex = 275 nm − λem = 314 nm.

The following HPLC procedure has been used to determine the amount of free Gd³⁺ ions:

Column: YMC-PACK ODS-AQ, 250 × 4.6 mm, 5 μm
Mobile phase: A = CH3COONH4 1.5 g/L, EDTA (0.55 g/L); B = MeOH

| t (min) | A | B | Flow (ml/min) |
|---|---|---|---|
| 0 | 100 | 0 | 1 |
| 5 | 100 | 0 | 1 |
| 10 | 50 | 50 | 1 |
| 15 | 50 | 50 | 1 |
| 16 | 100 | 0 | 1 |
| 25 | 100 | 0 | 1 |

Inj Volume: 20 um
Temperature: 40° C.
Detector: FLD detector: λex = 275 nm − λem = 314 nm.

### Example 1 (Comparative)—Precipitation of Compound 1 with Comparative Anti-Solvents

Several solutions having a concentration of 40 to 60% w/w of Compound 1 (1.0 g, 0.77 mmol) were prepared (first solutions). The following comparative anti-solvents were prepared and mixed with the first solutions:
t-amyl alcohol;
anisole;
isobutanol;
methanol; and
isopropanol.

After mixing, non-filtrable sticky solids or oils were obtained. Accordingly, none of the anti-solvents above allow obtaining a filterable solid of Compound 1 that can be later isolated.

### Example 2—Precipitation of Compound 1 Using the Second Solution

Several solutions having a concentration of 40 to 60% w/w of Compound 1 (1.0 g, 0.77 mmol) were prepared (first solutions). Several second solutions comprising ethanol were prepared, and mixed with the first solutions.

A solid precipitate was obtained for all trials. The formed precipitate had satisfactory but not great handling and transferability properties.

### Example 3—Precipitation of Compound 1 with Second Solution and Neutral Salt of Sodium, and Isolation of the Precipitate

NaCl was added (11.16 g, 0.19 mol, 1.46 mol eq) to a 50% w/w aqueous solution comprising Compound 1 (166.05 g, 0.13 mol) at 30° C. (first solution). The first solution was kept under stirring until complete dissolution. EtOH (996.31 g, 6 w/W_{Cpd1}—second solution) was loaded dropwise in 2 h. During the addition, a white suspension was observed in the reactor.

At the end of the load, the following temperature ramp was set up:
1. maintain at 20° C. for 30 min;
2. cool down to 5° C. in 6 h; and
3. maintain at 5° C. for 16 h.

After the temperature ramp, the mixture was filtered on a sintered glass funnel (porosity 4), and the filtered precipitated was washed with fresh absolute ethanol (166.05 g) previously cooled at 5° C.

The solid obtained was finally dried in a static oven under vacuum (<20 mbar) at 40° C.

The physical characterization of this precipitate of Compound 1 is showed in Table 1.

TABLE 1

| | | NaCl content | Precipitation |
|---|---|---|---|
| KF | wet/dry | (mol/mol_{Cpd1}) | yield |
| 8.60% | 2.2 | 1.1 | 90.6% |

Table 1 shows that the high precipitation yield, being even more than 90%.

Table 2 shows, within the solution before the precipitation and within the solid precipitate after the precipitation:
the main impurities that can typically be found within a solution of Compound 1 after its synthesis e.g. as disclosed in WO 2022/023240, namely Gd-DOTA and Gd-DO3A (Gd-DOTA is gadoteric acid; Gd-DO3A is the complex 2-[4,7-bis (carboxylatomethyl)-1,4,7-triaza-10-azanidacyclododec-1-yl]acetate;
gadolinium (3+)),
the minor impurities, that is free Gd³⁺ ions (Free-Gd) and mono-gadolinated complexes (Mono-Gd); and
the diastereoisomeric ratio of the three possible enantiomeric couples of Compound 1 (when D-glucamine is used for the synthesis of Compound 1 as e.g. disclosed in WO 2022/023240) indicated as D1, D2 and D3,
   expressed as the percentage of area detected via HPLC, fluorescence detector (% Area FLD), or as ppm/Compound 1 (for Free-Gd and Mono-Gd).

TABLE 2

| | | | | | | Free-Gd | Mono-Gd |
|---|---|---|---|---|---|---|---|
| | Gd-DOTA | Gd-DO3A | D1 | D2 | D3 | (ppm/Cpd. 1) | (ppm/Cpd. 1) |
| rtt vs D1 | 0.44 | 0.80 | 1.0 | 1.20 | 1.30 | | |
| (15.1 min) | | | | | | | |
| Before | 0.068 | 0.26 | 43.23 | 24.90 | 28.16 | 40 | n.q. |
| precipitation | | | | | | | |
| After | nd | 0.16 | 43.24 | 25.17 | 28.52 | 39 | n.q. |
| precipitation | | | | | | | |
| Percentage of | 100% | 39% | | | | | |
| purification | | | | | | | |

Table 2 clearly shows the purifying properties of the methods of the invention, in that both the main impurities Gd-DOTA and Gd-DO3A have been found lowered after precipitation.

Moreover, it is possible to observe that the diastereoisomeric ratio before and after precipitation is approximately the same.

Finally, Table 2 shows that the amount of the minor impurity (minor in the sense that they are present in lesser amount compared to the major impurities reported above) free Gd³⁺ ions (Free-Gd) remains substantially unchanged before and after precipitation; similarly, the amount of mono-gadolinated complexes (Mono-Gd) remains below the quantitation levels (n.q., which is 400 ppm). This means that the method of the invention when sodium chloride is used does not bring about a decomplexation of Compound 1.

### Example 4—Precipitation of Compound 1 with Second Solution and Neutral Salt of Sodium, and Isolation of the Precipitate

NaCl was added (5.89 g, 0.10 mol, 1.28 mol eq) to a 50% w/w water solution of Compound 1 (100.35 g, 0.078 mol) at 30° C. (first solution). The mixture was kept under stirring until complete solution. EtOH (416.4 g, 4.2 w/W_{Cpd.1}—second solution) was loaded dropwise in 2 h. During the addition, a white suspension is observed in the reactor.

At the end of the load, the following temperature ramp was set up:
1. maintain at 20° C. for 30 min;
2. cool down to 5° C. in 6 h;
3. maintain at 5° C. for 16 h.

After the temperature ramp, the mixture was filtered on a sintered glass funnel (porosity 4) and the filtered precipitated was washed with fresh absolute ethanol (100.4 g) previously cooled at 5° C.

The solid obtained was dried in a static oven under vacuum (<20 mbar) at 40° C.

The physical characterization of this precipitate is showed in Table 3.

TABLE 3

| | | NaCl content | Precipitation |
|---|---|---|---|
| KF | wet/dry | (mol/mol_{Cpd. 1}) | yield |
| 9.65% | 1.2 | 1.1 | 86.0% |

Table 4 shows, before and after precipitation, the main impurities and the diastereoisomeric ratio expressed as % Area FLD (or ppm/Compound 1 where expressed).

TABLE 4

| | | | | | | Free-Gd | Mono-Gd |
|---|---|---|---|---|---|---|---|
| Entry | Gd-DOTA | Gd-DO3A | D1 | D2 | D3 | (ppm/Cpd. 1) | (ppm/Cpd. 1) |
| rtt vs D1 | 0.44 | 0.80 | 1.0 | 1.20 | 1.30 | | |
| (15.1 min) | | | | | | | |
| Before | 0.18 | 0.07 | 44.40 | 24.20 | 27.90 | <50 | n.q. |
| precipitation | | | | | | | |
| After | 0.12 | 0.05 | 44.40 | 24.30 | 28.20 | <50 | n.q. |
| precipitation | | | | | | | |
| Percentage of | 34% | 30% | | | | | |
| purification | | | | | | | |

In view of the data presented in Tables 3 and 4, the same conclusions discussed above for Example 3 can be made for Example 4 as well.

### Example 5—Precipitation of Compound 1 with Second Solution and Neutral Salt of Sodium, and Isolation of the Precipitate

NaCl (2.22 g, 0.038 mol, 1.52 mol eq) was added to a 30% w/w water solution of Compound 1 (I) (31.9 g, 0.025 mol) at 30° C. and the mixture was kept under stirring until complete dissolution (first solution). EtOH (221.8 g, 7 w/W_{Cpd.1}—second solution) was loaded dropwise in 2 h. During the addition, a white suspension was observed in the reactor.

At the end of the load, the following temperature ramp was set up:
1. maintain at 20° C. for 30 min;
2. cool down to 5° C. in 6 h;
3. maintain at 5° C. for 16 h.

After the temperature ramp, the mixture was filtered on a sintered glass funnel (porosity 4) and the filtered precipitated was washed with fresh absolute ethanol (49.3 g) previously cooled at 4° C.

The solid obtained was dried in a static oven under vacuum (<20 mbar) at 40° C.

The physical characterization of this precipitate of Compound 1 is showed in Table 5, while Table 6 shows, before and after precipitation, the main impurities and the diastereoisomeric ratio expressed as % Area FLD (or as ppm/Compound 1 where expressed).

TABLE 5

| | | NaCl content | Precipitation |
|---|---|---|---|
| KF | wet/dry | (mol/mol_{Cpd. 1}) | yield |
| 8.67% | 1.9 | 1.2 | 86.2% |

TABLE 6

| | | | | | | Free-Gd | Mono-Gd |
|---|---|---|---|---|---|---|---|
| Entry | Gd-DOTA | Gd-DO3A | D1 | D2 | D3 | (ppm/Cpd. 1) | (ppm/Cpd. 1) |
| rtt vs D1 | 0.44 | 0.80 | 1.0 | 1.20 | 1.30 | | |
| (15.1 min) | | | | | | | |
| Before | 0.84 | 0.10 | 42.24 | 25.22 | 29.51 | 17 | n.q. |
| precipitation | | | | | | | |
| After | 0.27 | 0.04 | 40.11 | 26.39 | 31.26 | 11 | n.q. |
| precipitation | | | | | | | |
| Percentage of | 68% | 60% | | | | | |
| purification | | | | | | | |

Similarly to Tables 1 and 2, Tables 5 and 6 clearly show the good yield of the purification, as well as the purifying power and the maintenance of the diastereoisomeric ratio of the methods of the invention. Furthermore, it is possible to appreciate that also for this trial, the amount of free Gd³⁺ ions (Free-Gd) remains substantially unchanged before and after precipitation, and the amount of mono-gadolinated complexes (Mono-Gd) remains below the quantitation levels.

### Example 6—Precipitation of Compound 1 with Second Solution and Neutral Salt of Sodium, and Isolation of the Precipitate

NaCl (5.21 g, 0.09 mol, 1.5 mol eq) was added to a water solution of Compound 1 (77.49 g, 0.06 mol), and dense suspension was kept under stirring until complete dissolution of the salt (first solution).

The first solution was loaded dropwise (adding time=2+3 h) in a reactor equipped with mechanical stirring previously filled up with absolute ethanol (464.94 g, 6.0 w/W_{Cpd.1}—second solution) and kept at 20° C., while maintaining the stirring rate maintained at >350 rpm. During the addition, a white precipitate formation was observed.

At the end of the load, the following temperature ramp was set up:
1. maintain at 20° C. for 30 min;
2. cool down to 5° C. in 6 h;
3. maintain at 5° C. for 16 h.

After the temperature ramp, the mixture was filtered on a sintered glass funnel (porosity 4) and the filtered precipitated was washed with fresh absolute ethanol (77.49 g) previously cooled at 5° C. The solid obtained was dried in a static oven under vacuum (<20 mbar) at 40° C.

At the end, a white powder with a water content around 9.15% w/w was obtained, with a ratio of wet/dry around 1.9%. The yield of precipitation was 83.6%.

Table 7 shows, before and after precipitation, the main impurities and the diastereoisomeric ratio expressed as % Area FLD (or as ppm/Compound 1 where indicated).

TABLE 7

| | | | | | | Mono-Gd |
|---|---|---|---|---|---|---|
| Entry | Gd-DOTA | Gd-DO3A | D1 | D2 | D3 | (ppm/Cpd. 1) |
| rtt vs D1 (16.9 | 0.46 | 0.76 | | 1.11 | 1.20 | |
| min) | | | | | | |
| Before | 0.55 | 3.22 | 45.09 | 23.34 | 25.70 | 1564 |
| precipitation | | | | | | |
| After | 0.39 | 2.19 | 44.30 | 24.06 | 26.67 | 1378 |
| precipitation | | | | | | |
| Percentage of | 30% | 32% | | | | 12% |
| purification | | | | | | |

Table 7 shows the purifying power and the maintenance of the diastereoisomeric ratio of the methods of the invention. Table 7 further shows that, when a neutral salt of sodium is used, the method of the invention possesses purifying power even with respect to the mono-gadolinated complexes, which were in an amount above the quantitation levels before precipitation, such amount being lowered after precipitation.

### Example 7 (Comparative)—Precipitation of Compound 1 with Second Solution and Low Amount of Neutral Salt of Sodium

NaCl was added (3.16 g, 0.054 mol, 0.7 mol eq) to a 50% w/w water solution of Compound 1 (99.80 g, 0.077 mol) and the mixture was kept under stirring until complete dissolution (first solution). EtOH (399.21 g, 4.0 w/w) was loaded dropwise in 2 h. During the addition, the mixture turned to a sticky solid not agitable.

This comparative example shows that when the precipitating agent is present, it might have to be added in specific amounts to obtain a precipitate that can be further processed to isolate Compound 1.

### Example 8—Precipitation of Compound 1 with Second Solution and Organic Acid, and Isolation of the Precipitate

Acetic acid (2.31 g, 0.04 mol, 1 mol eq) was added to a water solution of Compound 1 (50% w/w, 46.75 g, 0.04 mol), and the resulting mixture was kept under stirring until complete homogenization (first solution). The pH of the solution was about 4.69.

The first solution was added dropwise (adding time=1+3 h) to a reactor equipped with mechanical stirring previously loaded with absolute ethanol (280.51 g, 6.0 w/W_{Cpd.1}—second solution) and kept at 20° C., while maintaining the stirring rate maintained at >350 rpm. During the addition, a white precipitate formation was observed.

At the end of the load, the following temperature ramp was set up:
1. maintain at 20° C. for 30 min;
2. cool down to 5° C. in 6 h;
3. maintain at 5° C. for 16 h.

After the temperature ramp, the mixture was filtered on a sintered glass funnel (porosity 4) and the filtered precipitated was washed with fresh absolute ethanol (1 w/w vs complex) previously cooled at 5° C. The solid obtained was dried in a static oven under vacuum (<20 mbar) at 40° C.

At the end, a white powder was obtained, with a ratio of wet/dry around 2.7%. The yield of precipitation was 84.0%.

Table 8 shows, before and after precipitation, the main impurities and the diastereoisomeric ratio expressed as % Area FLD (or as ppm/Cpd.1 where indicated).

TABLE 8

| | | | | | | Mono-Gd |
|---|---|---|---|---|---|---|
| Entry | Gd-DOTA | Gd-DO3A | D1 | D2 | D3 | (ppm/Cpd. 1) |
| rtt vs D1 (16.9 | 0.46 | 0.76 | | 1.11 | 1.20 | |
| min) | | | | | | |
| Before | 10.18 | 2.67 | 35.33 | 23.90 | 27.16 | n.q. |
| precipitation | | | | | | |
| After | 4.18 | 1.01 | 40.19 | 21.41 | 26.72 | 800 |
| precipitation | | | | | | |
| Percentage of | 59% | 62% | | | | |
| purification | | | | | | |

Table 8 shows the purifying power and the maintenance of the diastereoisomeric ratio of the methods of the invention. From Table 9 it can be further observed that, using organic acids as precipitating agents, the amount of mono-gadolinated complexes (Mono-Gd) is increased from not quantifiable (n.q.) to 800 ppm. This could be explained by the pH of the solution comprising Compound 1 after the acetic acid addition; acidic pH might promote the partial decomplexation of the complex, thereby generating mono-gadolinated complexes.

### Example 9—Precipitation of Compound 1 with Second Solution and Organic Acid (Lactic Acid), and Isolation of the Precipitate

An aqueous solution with a concentration of 50% w/w of lactic acid (1.24 g, 0.01 mol, 1 mol eq) was added to a water solution of Compound 1 (51% w/w, 17.80 g, 0.01 mol) and the resulting mixture was kept under stirring until complete homogenization (first solution). The pH of the solution was about 3.35.

The first solution was added dropwise (adding time=1.5 h) in a reactor equipped with mechanical stirring previously loaded with absolute ethanol (106.79 g, 6.0 w/W_{Cpd.1}—second solution) and kept at 20° C. During the addition, a precipitate formation was observed.

At the end of the load, the following temperature ramp was set up:
1. maintain at 20° C. for 30 min;
2. cool down to 5° C. in 6 h;
3. maintain at 5° C. for 16 h.

After the temperature ramp, the mixture was filtered on a sintered glass funnel (porosity 4). The solid obtained was dried in a static oven under vacuum (<20 mbar) at 40° C.

At the end, a white powder was obtained, with a ratio of wet/dry around 1.7%. The yield of precipitation is 90.3%.

Table 9 shows, before and after precipitation, the main impurities and the diastereoisomeric ratio expressed as % Area FLD (or as ppm/Cpd.1 where indicated).

TABLE 9

| | | | | | | Mono-Gd |
|---|---|---|---|---|---|---|
| Entry | Gd-DOTA | Gd-DO3A | D1 | D2 | D3 | (ppm/Cpd. 1) |
| rtt vs D1 (16.9 | 0.46 | 0.76 | | 1.11 | 1.20 | |
| min) | | | | | | |
| Before | nd | 0.78 | 37.07 | 28.95 | 31.76 | 298 |
| precipitation | | | | | | |
| After | nd | 0.51 | 37.54 | 28.80 | 31.58 | 3570 |
| precipitation | | | | | | |
| Percentage of | na | 35% | | | | |
| purification | | | | | | |

Table 9 shows the purifying power and the maintenance of the diastereoisomeric ratio of the methods of the invention. Moreover, from Table 9 it can be observed that, using organic acids as precipitating agents, the amount of mono-gadolinated complexes (Mono-Gd) is increased from 298 ppm to 3570 ppm. This could be explained by the pH of the solution comprising Compound 1 after lactic acid addition, which brings about partial de-complexation of Compound 1. Such de-complexation seems to occur in a higher amount compared to Example 8, because lactic acid (used in the present Examples) has a lower pKa compared to acetic acid (used in Example 8), thereby promoting even more de-complexation.

### Example 10 (Comparative)—Precipitation of Compound 1 with Second Solution and Carboxylate Salt

Potassium tartrate monobasic (4.78 g, 0.01 mol, 1 mol eq) was added to a 48% w/w aqueous solution of Compound 1 (16.45 g, 0.01 mol) at 20° C., and the mixture was kept under stirring until complete solution. EtOH (98.68 g, 6.0 w/W_{Cpd.1}) was loaded dropwise in 2 h. During the addition, the mixture turned to a sticky solid not agitable.

This comparative example shows that the type of precipitating agent is critical to obtain a precipitate that can be further processed to isolate Compound 1.

### Example 11 (Comparative)—Precipitation of Compound 1 with Second Solution and a High Amount of Organic Acid

Acetic acid (2.88 g, 0.05 mol, 10 mol eq) was added to a 52% w/w aqueous solution of Compound 1 (6.20 g, 0.005 mol) at 20° C., and the mixture was kept under stirring until complete dissolution. EtOH (49.58 g, 8 w/W_{Cpd.1}) was loaded dropwise in 2 h. During the addition, the mixture turned to a sticky solid not agitable.

Similarly to comparative Example 7, this comparative example shows that when the precipitating agent is present, it might have to be added in specific amounts to obtain a precipitate that can be further processed to isolate the complex of formula (I).

### Example 12—Precipitation of Compound 1 with Second Solution and Neutral Salt of Sodium (NaBr), and Isolation of the Precipitate

NaBr (3.97 g, 0.039 mol, 1 mol eq) was added to a 58% w/w aqueous solution of Compound 1 (49.90 g, 0.039 mol) at 30° C. (first solution), and the mixture was kept under stirring. EtOH (199.60 g, 4 w/W_{Cpd.1}—second solution) was loaded dropwise in 2 h.

At the end of the load, the following temperature ramp was set up:
1. maintain at 20° C. for 30 min;
2. cool down to 5° C. in 6 h;
3. maintain at 5° C. for 16 h.

After the temperature ramp, the mixture was filtered on a sintered glass funnel (porosity 4) and the filtered precipitated was washed with fresh absolute ethanol (99.80 g) previously cooled at 5° C. The solid obtained was dried in a static oven under vacuum (<20 mbar) at 40° C.

The physical characterization of this precipitate Compound 1 is showed in Table 9, while Table 10 shows, before and after precipitation, the main impurities and the diastereoisomeric ratio expressed as % Area FLD (or as ppm/Cpd. 1 where indicated).

TABLE 9

| | | NaBr content | Precipitation |
|---|---|---|---|
| KF | wet/dry | mol/mol_{Cpd. 1} | yield |
| 4.98% | 1.45 | 1.1 | 85.95 |

TABLE 10

| | | | | | | Free-Gd | Mono-Gd |
|---|---|---|---|---|---|---|---|
| Entry | Gd-DOTA | Gd-DO3A | D1 | D2 | D3 | (ppm/Cpd. 1) | (ppm/Cpd. 1) |
| rtt vs D1 | 0.44 | 0.80 | 1.0 | 1.20 | 1.30 | | |
| (15.1 min) | | | | | | | |
| Before | 0.42 | 0.19 | 43.68 | 23.91 | 28.06 | 12 | nq |
| precipitation | | | | | | | |
| After | 0.29 | 0.14 | 41.44 | 22.54 | 27.07 | 16 | nq |
| precipitation | | | | | | | |
| Percentage of | 31% | 26% | | | | | |
| purification | | | | | | | |

Similarly to Tables 1 and 2, Tables 9 and 10 clearly show the good yield of the purification, as well as the purifying power and the maintenance of the diastereoisomeric ratio of the methods of the invention. Furthermore, it is possible to appreciate that also for this trial, both free free Gd³⁺ ions (Free-Gd) and of mono-gadolinated complexes (Mono-Gd) remain substantially unchanged before and after precipitation.

### Example 13 (Comparative)—Precipitation of Compound 1 with Second Solution and a Neutral Salt of Potassium

KCl (2.88 g, 0.039 mol, 1 mol eq) was added to a 58% w/w aqueous solution of Compound 1 (49.90 g, 0.039 mol) at 30° C., and the mixture was kept under stirring until complete dissolution. EtOH (199.60 g, 4 w/W_{Cpd.1}) was loaded dropwise in 2 h. During the addition, the mixture turned to a sticky solid not agitable.

Similarly to comparative Example 10, this comparative example shows that the type of precipitating agent is critical to obtain a precipitate that can be further processed to isolate the complex of formula (I).

### Summary of Examples 1 to 13

Table 11 summarizes the trials of Examples 1 to 13 and the results thereof, highlighting for each Example if a filterable solid was obtained, the yield of the precipitation (where applicable and determined), as well as the percentage of the purification of the two impurities Gd-DOTA and Gd-DO3A (respectively, % purif. DOTA and % purif. DO3A, where applicable and determined).

TABLE 11

| | | | Prec. | | | | |
|---|---|---|---|---|---|---|---|
| | | Prec. | ag. mol. | Filterable | | % purif. | % purif. |
| Ex. # | Anti-solv. | agent | eq. | solid | Yield | DOTA | DO3A |
| 1 | Not comprising | n.a. | n.a. | No | n.a. | n.a. | n.a. |
| (Comp.) | EtOH | | | | | | |
| 2 | EtOH | n.a. | n.a. | Yes | n.d. | n.d. | n.d. |
| 3 | EtOH | NaCl | 1.46 | Yes | 90.6 | 100 | 39 |
| 4 | EtOH | NaCl | 1.28 | Yes | 86.0 | 34 | 30 |
| 5 | EtOH | NaCl | 1.52 | Yes | 86.2 | 68 | 60 |
| 6 | EtOH | NaCl | 1.5 | Yes | 83.6 | 30 | 32 |
| 7 | EtOH | NaCl | 0.7 | No | n.a. | n.a. | n.a. |
| (Comp.) | | | | | | | |
| 8 | EtOH | Acetic ac. | 1 | Yes | 84.0 | 59 | 62 |
| 9 | EtOH | Lactic ac. | 1 | Yes | 90.3 | n.d. | 35 |
| 10 | EtOH | K tartrate | 1 | No | n.a. | n.a. | n.a. |
| (Comp.) | | monobasic | | | | | |
| 11 | EtOH | Acetic ac. | 10 | No | n.a. | n.a. | n.a. |
| (Comp.) | | | | | | | |
| 12 | EtOH | NaBr | 1 | Yes | 85.95 | 31 | 26 |
| 13 | EtOH | KCl | 1 | No | n.a. | n.a. | n.a. |
| (Comp.) | | | | | | | |

1) A method for precipitating the complex of formula (I) from a solution thereof 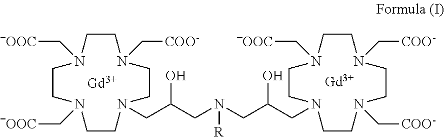
wherein R is a C₂-C₆-alkyl substituted by at least one hydroxyl (—OH) group, said method comprising the following steps:
a) providing a first solution comprising the complex of formula (I);
b) providing a second solution comprising ethanol; and
c) mixing the first solution of step a) with the second solution of step b) to precipitate the complex of formula (I).

2) (canceled)

3) The method according to claim 1, wherein R is a C₄-C₆-alkyl substituted by at least one hydroxyl (—OH) group.

4) (canceled)

5) (canceled)

6) The method according to claim 3, wherein the complex is Compound 1

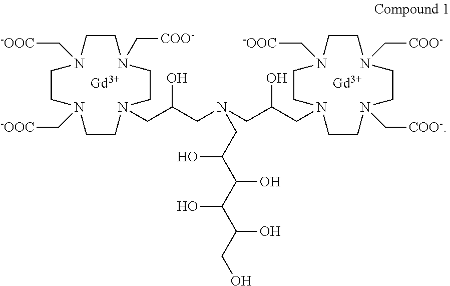

7) The method according to claim 1, wherein the mixture prepared according to step c) further comprises at least a precipitating agent selected from the group consisting of neutral salts of sodium and organic acids, said precipitating agent being in an amount higher than 0.7 molar equivalents and lower than 10.0 molar equivalents with respect to the complex of formula (I).

8) (canceled)

9) The method according to claim 7, wherein the precipitating agent is in an amount of 0.9 to 5.0 molar equivalents with respect to the complex of formula (I).

10) (canceled)

11) The method according to claim 9, wherein the precipitating agent is in an amount of 1.0 to 2.0 molar equivalents with respect to the complex of formula (I).

12) The method according to claim 7, wherein the neutral salt of sodium is selected from the group consisting of sodium chloride, sodium bromide, sodium iodide, sodium fluoride, sodium nitrate, and sodium sulfate.

13) The method according to claim 12, wherein the neutral salt of sodium is selected from the group consisting of sodium chloride and sodium bromide.

14) The method according to claim 7, wherein the organic acid is a C₁-C₆-(hydroxy)alkyl-carboxylic acid.

15) (canceled)

16) The method according to claim 14, wherein the organic acid is selected from the group consisting of acetic acid, lactic acid, tartaric acid, and citric acid.

17) The method according to claim 16, wherein the organic acid is selected from the group consisting of acetic acid and lactic acid.

18) The method according to claim 1, wherein the concentration of the complex within the first solution is 20% to 70% w/w.

19) (canceled)

20) The method according to claim 1, wherein the mixing of step c) is carried out so that the amount in weight of ethanol is from 1 to 20 times with respect to the amount in weight of the complex of formula (I).

21) (canceled)

22) (canceled)

23) The method according to claim 20, wherein the mixing of step c) is carried out so that the amount of weight of ethanol is from 4 to 8 times with respect to the amount in weight of the complex of formula (I).

24) A method for isolating a complex of formula (I) from a mixture 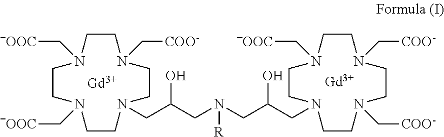
wherein R is a C₂-C₆-alkyl substituted by at least one hydroxyl (—OH) group, said method for isolating comprising the following steps:
(i) carrying out the method according to claim 1 to obtain a precipitate of the complex within a mixture; and
(ii) filtering out the precipitate of the complex from the mixture.

25) (canceled)

26) The method according to claim 24, wherein R is a C₄-C₆-alkyl substituted by at least one hydroxyl (—OH) group.

27) (canceled)

28) The method according to claim 26, wherein R is a C₆-alkyl substituted by at least one hydroxyl (—OH) group.

29) The method according to claim 28, wherein the complex is Compound

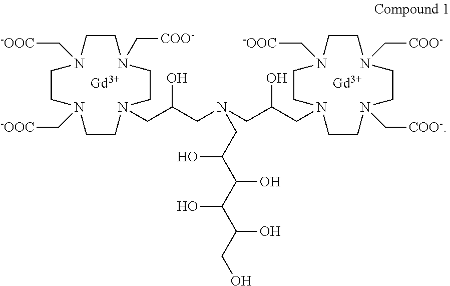

30) The method according to claim 24, wherein before step (ii), the temperature of the mixture is lowered to 0° C. to 10° C.

31) (canceled)

32) The method according to claim 30, wherein the temperature is gradually lowered for a time of 6 to 48 hours.

33) The method according to claim 32, wherein the temperature is gradually lowered for a time of 12 to 36 hours.

34) (canceled)
